(19) United States
(12) Patent Application Publication
(10) Pub. No.: US 2006/0086018 A1
(43) Pub. Date: Apr. 27, 2006

(54) Windbell with snowman ornaments

(76) Inventor: Hon Kwok Cheng, Kowloon (HK)

Correspondence Address: RABIN & Berdo, PC, 1101 14TH STREET, NW, SUITE 500, WASHINGTON, DC, 20005, US

(21) Appl. No.: 11/130,144

(22) Filed: May 17, 2005

(30) Foreign Application Priority Data
Jul. 14, 2004 (CN) 200420077774.6

(51) Int. Cl. G09F 19/08

(52) U.S. Cl. 40/411

(57) ABSTRACT

A windbell having a plurality of hanging snowman strings attached to the circumference of a ring is provided. According to the invention, the snowmen of the windbell are made of transparent acrylic material and a luminescent lamp connected with a transparent wire is arranged in each of said snowmen; said ring is a also made of transparent acrylic material; the transparent wires from the luminescent lamps are attached to said transparent ring and then clustered on the top to be connected with a suspension battery box on which a power switch with a sound-control function is provided. The suspension battery box is formed by buckling of two semi-circular box covers. The invented windbell is brilliant and twinkling under irradiation of lights to display an excellent decorative effect, because of the integration of the transparent acrylic snowman windbells and the luminescent lamps.

### FIELD OF THE INVENTION

The present invention relates to a windbell.

### BACKGROUND OF THE INVENTION

Windbells are hung up in a room for interior decoration. A wide variety of windbells are currently available, the hanging ornaments of which are mainly made of metal tubes or woven with decorative ribbons. These windbells seem to display a similar and dull style without new features.

### SUMMARY OF THE INVENTION

An object of the present invention is to provide a novel windbell with snowman ornaments for generating an excellent decorative effect.

In order to accomplish the aforesaid object, there is provided a windbell having a plurality of hanging snowman strings attached to the circumference of a ring, characterized in that said snowmen on the strings are made of transparent acrylic material and a luminescent lamp connected with a transparent wire is arranged in each of said snowmen; said ring is also made of transparent acrylic material; the transparent wires from the luminescent lamps are attached to said transparent ring and then clustered on the top to be connected with a suspension battery box on which a power switch with a sound-control function is provided.

Said suspension battery box is formed by buckling of two semi-circular box covers.

Said power switch with the sound-control function is provided on the bottom of the circular battery box.

The windbell according to the invention is brilliant and twinkling under irradiation of lights to display an excellent decorative effect, because of the integration of the transparent acrylic snowmen and the luminescent lamps.

The invention will now be described in more detail with reference to the accompanying figure drawing.

### BRIEF DESCRIPTION OF THE DRAWINGS

FIG. 1 is a diagrammatic view showing the construction of the windbell according to the invention.

### DETAILED DESCRIPTION OF THE INVENTION

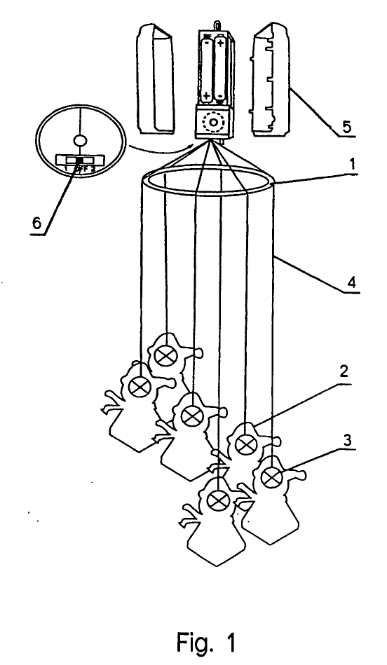

Referring to FIG. 1, the windbell has a plurality of hanging snowman strings attached to the circumference of a transparent acrylic ring 1. The snowmen 2 are made of transparent acrylic material and a luminescent lamp 3 connected with a transparent wire 4 is arranged in each of said snowmen 2. The transparent wires 4 from the luminescent lamps 3 are attached to said ring 1 and then clustered on the top to be connected with a suspension battery box on which a power switch 6 with a sound-control function 7 is provided. The suspension battery box is formed by buckling of two semi-circular box covers 5. The power switch 6 with the sound-control function 7 is provided on the bottom of the circular battery box.

The luminescent lamps inside the transparent snowmen may be devised to employ color LEDs so as to display various colors.

Numerous variations and modifications are easily obtainable by means of the skilled person's common knowledge without departing from the scope of the invention, however, such variations and modifications should fall into the scope of this invention.

1. A windbell, comprising:
a suspension battery box on which a power switch with a sound-control function is provided:
a ring made of a transparent acrylic material;
a plurality of transparent wires connected to a circumference of said ring; a plurality of hanging snowman attached to the circumference of the ring using said wires, said snowmen made of transparent acrylic material; and
a luminescent lamp connected with a respective transparent wire and being arranged in each of said snowmen;
wherein the transparent wires from the luminescent lamps are attached to said transparent ring and then clustered on the top to be connected with the suspension battery box.

2. The windbell as claimed in claim 1, wherein said suspension battery box is circular, and is formed of two semi-circular box covers buckled together.

3. The windbell as claimed in claim 2, wherein said power switch with the sound-control function is provided on a bottom of the circular battery box.
